(19) United States
(12) Patent Application Publication
(10) Pub. No.: US 2025/0159070 A1
(43) Pub. Date: May 15, 2025

(54) METHOD OF OPERATING BLUETOOTH AUDIO MODE OF VEHICLE, VEHICLE CONTROL DEVICE SUPPORTING SAME, AND VEHICLE COMPUTING SYSTEM SUPPORTING SAME

(71) Applicants: Hyundai Motor Company, Seoul (KR); Kia Corporation, Seoul (KR)

(72) Inventor: Hyun Woo Lee, Seoul (KR)

(21) Appl. No.: 18/613,046

(22) Filed: Mar. 21, 2024

(30) Foreign Application Priority Data
Nov. 10, 2023 (KR) 10-2023-0155739

(51) Int. Cl. H04M 1/72409; H04M 1/72412

(52) U.S. Cl. CPC H04M 1/724098; H04M 1/72412

(57) ABSTRACT

In an embodiment a vehicle control device includes a communication circuit configured to provide a communication channel with a portable terminal and a vehicle processor functionally connected to the communication circuit, wherein the vehicle processor is configured to start a monitoring routine to switch a media mode of a vehicle to a Bluetooth audio mode, to check whether a received signal is a pre-specified signal when a signal related to a Bluetooth audio mode switch is received from the portable terminal through the communication circuit, and to switch the media mode to the Bluetooth audio mode when the received signal is the pre-specified signal.

### CROSS-REFERENCE TO RELATED APPLICATIONS

This application claims the benefit of Korean Patent Application No. 10-2023-0155739, filed on Nov. 10, 2023, which application is hereby incorporated herein by reference.

### TECHNICAL FIELD

The present disclosure relates to an audio output function of a vehicle, and more particularly, to a technology capable of improving the operation of a Bluetooth audio mode of a vehicle.

### BACKGROUND

An audio video navigation telematics (AVNT) system, which is a sub-concept that constitutes a vehicle infotainment system, refers to a device that encompasses connected car services, media, navigation, and personalization functions. The term AVNT is a combination of the initials of audio, video, navigation, and telecommunication which are core functions. In the past, an AVNT system was called AVN because the AVNT system is equipped with only basic media and navigation functions, but the AVNT system has been able to provide a wider range of content and information with the introduction of telecommunication (T), which combines connected car services.

As an example, the AVNT system of a vehicle supports various media modes related to content playback control and the various media modes include a Bluetooth audio mode. The user may enter a specific media mode by manipulating the user interface provided by a vehicle AVNT system.

In addition, the AVNT system of a vehicle supports connection with a portable terminal (e.g., a smartphone) and supports output of content being played on the portable terminal through the video and audio system of the vehicle. However, as mentioned above, because the AVNT system of a vehicle supports various media modes, it is not possible to output the content being played on the portable terminal simply by connecting the portable terminal, but there is a need to establish various settings by manipulating a user interface for the AVNT system of the vehicle. However, because such setting establishment is somewhat complicated and takes time, it causes various inconveniences when considering the driving preparation situation or driving situation.

### SUMMARY

Embodiments provide a method for operating a Bluetooth audio mode capable of more easily processing the operation of the Bluetooth audio mode by using a portable terminal, a vehicle control device supporting the same, and a vehicle computing system supporting the same.

According to an embodiment of the present disclosure, a vehicle control device supporting a Bluetooth audio mode operation includes a communication circuit that provide a communication channel with a portable terminal, and a vehicle processor functionally connected to the communication circuit, wherein the vehicle processor starts a monitoring routine to switch a media mode of the vehicle to a Bluetooth audio mode, checks whether a received signal is a pre-specified signal when a signal related to a Bluetooth audio mode switch is received from the portable terminal through the communication circuit, and switches the media mode to the Bluetooth audio mode when the received signal is the pre-specified signal.

According to an embodiment, the vehicle processor may perform the Bluetooth audio mode switch when there is a time difference between playback time notifications related to a periodic playback time notification and a received actual advanced audio distribution profile (A2DP) audio data packet after a streaming ready state entry signal and a streaming start signal are received.

According to an embodiment, the vehicle processor may restart a routine of monitoring the Bluetooth audio mode switch when receiving a streaming stop signal.

According to an embodiment, the vehicle processor may compare the pre-specified signal to the received signal by checking a type of the portable terminal.

According to an embodiment, the vehicle processor may transmit to the portable terminal a query about checking whether the portable terminal is equipped with a first type operating system, and check the type of the portable terminal according to a response received from the portable terminal.

According to an embodiment, the vehicle processor may transmit a query including AT+APLSISI to the portable terminal to check whether the portable terminal is equipped with an iOS operating system and determine that the portable terminal is an Apple® device when a response value from the portable terminal is 1 or 2.

According to an embodiment, the vehicle processor may check whether an actual advanced audio distribution profile (A2DP) audio data packet is received when checking an audio/video remote control profile (AVRCP) play state, wherein the vehicle processor is in the AVRCP play state after receiving a streaming ready state entry signal and a streaming start signal when it is determined that the portable terminal is the Apple® device, and switch to the Bluetooth audio mode when the AVRCP play state is maintained while receiving the A2DP audio data packet.

According to an embodiment, the vehicle processor may transmit a query including AT+APLSISI to the portable terminal to check whether the portable terminal is equipped with an iOS operating system; and determine that the portable terminal is a portable terminal other than an Apple® device when there is no response from the portable terminal or when a response value is 0.

According to an embodiment, the vehicle processor may periodic playback time notification after receiving a streaming ready state entry signal and a streaming start signal when determining that the portable terminal is a portable terminal other than the Apple® device, check whether an actual advanced audio distribution profile (A2DP) audio data packet is received when the periodic playback time notification is confirmed, and switch to the Bluetooth audio mode when there is a time difference between the periodic playback time notifications and the actual A2DP audio data packet.

According to another embodiment of the present disclosure, a method of operating a Bluetooth audio mode of a vehicle includes starting, by a processor of a vehicle, a monitoring routine to switch a media mode of the vehicle to a Bluetooth audio mode; checking, by the processor, whether a signal from a portable terminal through a communication circuit of the vehicle is received, the signal being related a Bluetooth audio mode switch; determining, by the processor, whether the received signal is a pre-specified signal; and switching, by the processor, the media mode to the Bluetooth audio mode when the received signal is the pre-specified signal.

According to an embodiment, wherein checking whether the signal is received comprises checking whether there is a time difference between playback time notifications related to a periodic playback time notification and an actual advanced audio distribution profile (A2DP) audio data packet after a streaming ready state entry signal and a streaming start signal are received.

According to an embodiment, wherein checking whether the signal is received may further comprise restarting a routine of monitoring the Bluetooth audio mode switch after receiving a streaming stop signal.

According to an embodiment, wherein checking whether the signal is received may comprise comparing the pre-specified signal to the received signal by a type of the portable terminal.

According to an embodiment, checking the type of portable terminal may comprise transmitting, to the portable terminal, a query about whether the portable terminal is equipped with a first type operating system, and checking the type of the portable terminal according to a response received from the portable terminal.

According to an embodiment, the checking of the type of the portable terminal may comprise transmitting a query including AT+APLSISI to the portable terminal to check whether the portable terminal is equipped with an iOS operating system; and determining that the portable terminal is an Apple® device when a response value from the portable terminal is 1 or 2.

According to an embodiment, the switching to the Bluetooth audio mode may comprise checking whether an actual advanced audio distribution profile (A2DP) audio data packet is received when checking an audio/video remote control profile (AVRCP) play state, wherein the processor is in the AVRCP play state after receiving a streaming ready state entry signal and a streaming start signal when it is determined that the portable terminal is the Apple® device, and switching to the Bluetooth audio mode when the AVRCP play state is maintained while receiving the A2DP audio data packet.

According to an embodiment, the checking of the type of the portable terminal may comprise transmitting a query including AT+APLSISI to the portable terminal to check whether the portable terminal is equipped with an iOS operating system; and determining that the portable terminal is a portable terminal other than an Apple® device when there is no response from the portable terminal or when a response value is 0.

According to an embodiment, the switching to the Bluetooth audio mode may include checking a periodic playback time notification after receiving a streaming ready state entry signal and a streaming start signal when determining that the portable terminal is a portable terminal other than the Apple® device, checking whether an actual advanced audio distribution profile (A2DP) audio data packet is received when the periodic playback time notification is confirmed, and switching to the Bluetooth audio mode when there is a time difference between the periodic playback time notifications and the actual A2DP audio data packet.

According to yet another embodiment of the present disclosure, a vehicle computer system includes a vehicle processor that supports a vehicle operation and a memory that stores at least one instruction for operating the vehicle processor, wherein the at least one instruction stored in the memory causes the vehicle processor to start a monitoring routine to switch a media mode of the vehicle to a Bluetooth audio mode, check whether a signal related to a Bluetooth audio mode switch is received from a portable terminal through a communication circuit of the vehicle, determine whether the received signal is a pre-specified signal, and switch the media mode of to the Bluetooth audio mode when the received signal is the pre-specified signal.

According to an embodiment, the at least one instruction causes the vehicle processor to restart a routine of monitoring the Bluetooth audio mode switch when a streaming stop signal is received.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating an example of a vehicle audio operation environment according to an embodiment of the present disclosure;

FIG. 2 is a block diagram illustrating an example of a configuration of a vehicle AVNT in a vehicle audio operation environment according to an embodiment of the present disclosure;

FIG. 3 is a block diagram illustrating an example of a configuration of a portable terminal in a vehicle audio operation environment according to an embodiment of the present disclosure;

FIG. 4 is a flowchart illustrating an example of a method of operating a Bluetooth audio mode of a vehicle AVNT system according to an embodiment of the present disclosure;

FIG. 5 is a flowchart illustrating another example of a method of operating a Bluetooth audio mode of a vehicle AVNT system according to an embodiment of the present disclosure;

FIG. 6 is a diagram illustrating an example of a method of operating a Bluetooth audio mode of a vehicle AVNT system related to a first type portable terminal according to an embodiment of the present disclosure;

FIG. 7 is a diagram illustrating an example of a method of operating a Bluetooth audio mode of a vehicle AVNT system related to a second type portable terminal according to an embodiment of the present disclosure; and

FIG. 8 is a block diagram illustrating a computing system according to each embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, the user's intention to operate Bluetooth audio is identified during the Bluetooth connection process between a vehicle AVNT system and a portable terminal, and a scheme that supports the Bluetooth audio mode switching of the vehicle AVNT system more easily even without additional manipulation of the vehicle AVNT system according to the identified intention. Various embodiments of this will be described in detail with reference to the drawings.

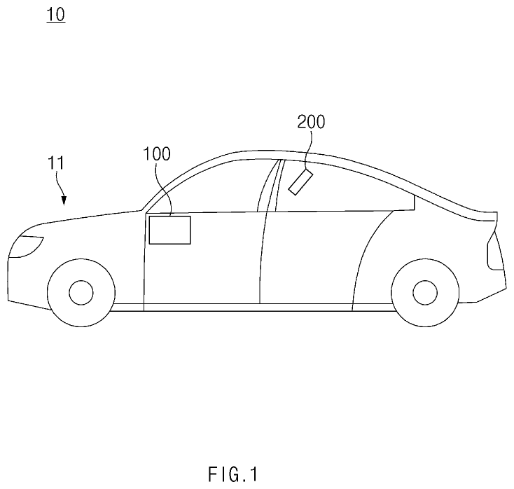

FIG. 1 is a diagram illustrating an example of a vehicle audio operation environment according to an embodiment of the present disclosure.

Referring to FIG. 1, a vehicle audio operation environment 10 according to an embodiment of the present disclosure may include a vehicle AVNT system 100 (or a vehicle control device, a vehicle control module, and a vehicle control system) built into a vehicle 11, and at least one portable terminal 200 (e.g., a smartphone) that operates a Bluetooth audio mode in communication with the vehicle AVNT system 100.

The vehicle 11 may include a vehicle body for accommodating a driver and at least one occupant, a plurality of wheels for moving the vehicle body, a driving device for generating power to drive the plurality of wheels, at least one shaft and gears for transmitting the power generated by the driving device to the plurality of wheels, a steering device for steering the vehicle 11, and a brake system for controlling the speed of the vehicle 11. In particular, the vehicle 11 may include at least the vehicle AVNT system 100 (or a vehicle computing device, a computing system, a control device, a motor control unit, a vehicle control system) capable of supporting a content multiple output function according to the present disclosure after the ignition is turned on. The vehicle AVNT system 100 may receive a signal transmitted by the portable terminal 200 and switch to the Bluetooth audio mode according to the signal transmitted by the portable terminal 200. As an example, the vehicle AVNT system 100 performs initialization when a specific event occurs (e.g., the ignition is turned on or the accelerator is pressed more than a reference value), and after initialization is completed, may perform a pre-specified media mode.

As an example, the vehicle AVNT system 100 may collect status values of various elements constituting the vehicle 11 and output the collected status values to a display of the vehicle 11. After initialization is completed, the vehicle AVNT system 100 may output a mode list output screen on the display of the vehicle 11 where one of various media modes may be selected. In this operation, the vehicle AVNT system 100 may start monitoring for Bluetooth audio mode switching. Alternatively, the vehicle AVNT system 100 may start (or execute) a monitoring routine related to performing the Bluetooth audio mode after the ignition is turned on. When the monitoring routine related to Bluetooth audio mode switching begins, the vehicle AVNT system 100 may check whether a streaming ready state entry signal (AVDTP Stream Establishment) is received from the portable terminal 200. When the streaming ready state entry signal is received, the vehicle AVNT system 100 may check whether a streaming data transmission start signal (AVDTP Stream Start) is received, and may check a media playback time change when the streaming data transmission start signal is received. In the process of checking whether the playback time is updated, when the playback time is updated, the vehicle AVNT system 100 may check whether actual audio data (A2DP audio data packet) for content playback is received, and may change to the Bluetooth audio mode when the actual audio data is received. Meanwhile, when the vehicle AVNT system 100 receives a streaming stop signal (AVDTP Stream Suspended) while performing the above-described routine, the vehicle AVNT system 100 may return to the monitoring start operation for switching to the Bluetooth audio mode and may re-perform the following operations. For example, the vehicle AVNT system 100 may restart the monitoring routine for switching to the Bluetooth audio mode.

As described above, while monitoring Bluetooth audio mode switching with the portable terminal 200, the vehicle AVNT system 100 of the present disclosure may check transmission and reception of a signal (or at least one of a control signal and a data signal) related to Bluetooth operation, recognize that the portable terminal 200 switches to a Bluetooth audio mode when a specific control signal predefined is received, and control to switch to the Bluetooth audio mode accordingly. Thus, the vehicle AVNT system 100 of the present disclosure may support more convenient mode switching by allowing the Bluetooth audio mode to be switched by manipulating the portable terminal 200 without the user directly manipulating the vehicle AVNT system.

The at least one portable terminal 200 may be located within the vehicle 11 as the user boards the vehicle 11 while holding the portable terminal 200. In the drawings, a situation in which one portable terminal 200 is disposed within the vehicle 11 is illustrated, but an embodiment of the present disclosure is not limited thereto. For example, a plurality of portable terminals may be disposed in the vehicle 11, and each of the plurality of portable terminals may be connected to the vehicle AVNT system 100 in response to a user operation or depending on whether the vehicle AVNT system 100 allows it, and operate in the Bluetooth audio mode. Alternatively, the plurality of portable terminals may have access authority to the vehicle AVNT system 100 alternately according to user input or by a portable terminal having a specific priority, and may operate in the Bluetooth audio mode by the portable terminal that obtains access authority. The portable terminal 200 may not only connect to the vehicle AVNT system 100 through Bluetooth, but also may be connected to a plurality of other peripheral devices (e.g., an earphone device or a wireless headset device) through Bluetooth. For example, the portable terminals 200 described above may have different operating systems from various manufacturers, and may have different connection conditions or schemes with the vehicle AVNT system 100. As an example, the portable terminal 200 may include at least one of a portable terminal equipped with Android operating system (OS) or a portable terminal equipped with iOS. The portable terminal 200 may perform Bluetooth pairing with the vehicle AVNT system 100 in response to user manipulation and transmit audio data according to content playback to the vehicle AVNT system 100.

As described above, even in a situation where the vehicle AVNT system 100 does not prepare a Bluetooth audio mode for the portable terminal 200, when a signal related to the operation of the Bluetooth audio mode of the portable terminal 200 is received, the vehicle audio operation environment 10 according to an embodiment of the present disclosure may support the vehicle AVNT system 100 to receive audio data transmitted by the portable terminal 200 and output it through the audio system in the vehicle 11. Thus, the vehicle audio operation environment 10 of the present disclosure may allow the vehicle AVNT system 100 to automatically switch to the Bluetooth audio mode through manipulation of the portable terminal 200 even in an environment where it is difficult for the occupants to directly operate the vehicle AVNT system 100, such as in the rear seat of the vehicle 11, so that it is possible to support a more stable content operation environment. In addition, by enabling the driver of the vehicle 11 to listen to content through the portable terminal 200 only by simply manipulating the content playback of the portable terminal 200, without operating the separate vehicle AVNT system 100, it is possible to provide an environment in which the driver may easily concentrate on driving the vehicle 11. In addition, the vehicle audio operation environment 10 of the present disclosure supports easy Bluetooth mode switching regardless of the type of portable terminal 200 or the operating system installed in the portable terminal 200.

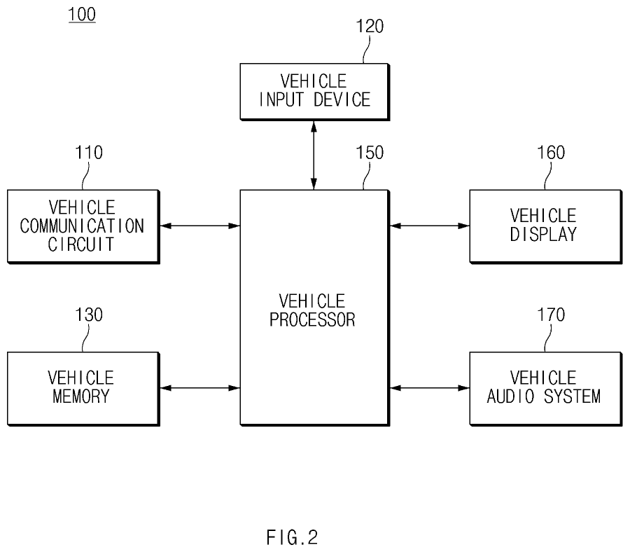

FIG. 2 is a block diagram illustrating an example of a configuration of a vehicle AVNT in a vehicle audio operation environment according to an embodiment of the present disclosure.

Referring to FIG. 2, the vehicle AVNT system 100 (or a vehicle computing system or a vehicle control device) according to an embodiment of the present disclosure may include a vehicle communication circuit 110, a vehicle input device 120, a vehicle display 160, a vehicle memory 130, a vehicle audio system 170, and a vehicle processor 150.

The vehicle communication circuit 110 may support a communication function of the vehicle 11. As an example, the vehicle communication circuit 110 may form a communication channel between the vehicle AVNT system 100 and peripheral components, such as the vehicle input device 120, the vehicle display 160, the vehicle audio system 170, and the vehicle memory 130. In this regard, the vehicle communication circuit 110 may form a wired communication channel connecting the vehicle AVNT system 100 and peripheral components. In addition, the vehicle communication circuit 110 may form a communication channel with the at least one portable terminal 200. As an example, the vehicle communication circuit 110 may receive content audio data from the portable terminal 200 and transmit the received content audio data to the vehicle audio system 170 under control of the vehicle processor 150.

The vehicle input device 120 may include a device capable of generating at least one input signal related to operation of the vehicle 11. As an example, the vehicle input device 120 may generate an input signal corresponding to a user input related to driving of the vehicle 11 and a user input for connection to the portable terminal 200, and transmit the generated signal to the vehicle processor 150. Alternatively, the vehicle input device 120 may generate at least one input signal related to the operation of the vehicle AVNT system 100 in response to user manipulation and transmit the generated input signal to the vehicle processor 150.

The vehicle display 160 may output at least one screen related to the operation of the vehicle 11. For example, the vehicle display 160 may output a navigation screen related to the current driving state of the vehicle 11, the moving speed of the vehicle 11, the movement of the vehicle 11, and like. Alternatively, the vehicle display 160 may output at least one screen related to operation of the vehicle AVNT system 100. For example, the vehicle display 160 may output a screen related to the current running media mode, a screen indicating the connection state with the portable terminal 200, a screen related to mode switching related to Bluetooth mode operation of the portable terminal 200, and a screen outputting text data or image data among data provided by the portable terminal 200.

The vehicle memory 130 may store various data necessary for operating the vehicle 11. As an example, the vehicle memory 130 may store storage values related to a seat posture state of the vehicle 11, operation records of the vehicle 11, map information related to the operation of the vehicle 11, navigation programs, and the like. As an example, the vehicle memory 130 may store at least some of at least one program, routine, or data related to Bluetooth audio mode operation according to an embodiment of the present disclosure. Alternatively, the vehicle memory 130 may temporarily or semi-permanently store at least some of the control signals and audio data transmitted and received with the portable terminal 200.

The vehicle audio system 170 may include at least one audio device built into the vehicle 11. As an example, the vehicle audio system 170 may include at least one speaker or at least one woofer installed in the vehicle 11. The vehicle audio system 170 may be connected to the vehicle processor 150 by wire and may output at least a portion of the audio signal received by the vehicle communication circuit 110 under control of the vehicle processor 150. As an example, the vehicle audio system 170 may output at least a portion of audio data of content played on the portable terminal 200.

The vehicle processor 150 may control the transmission and processing of signals related to the operation of the vehicle 11, and storage of processing results, or the output of various signals related to the operation of the vehicle 11. As an example, the vehicle processor 150 may perform Bluetooth audio mode switching in response to manipulation of the portable terminal 200 without direct manipulation of the vehicle AVNT system 100 (or direct manipulation of the vehicle input device 120) based on at least one routine related to Bluetooth audio mode switching.

The vehicle processor 150 may start the monitoring routine for switching the media mode of the vehicle to the Bluetooth audio mode, check whether a received signal is a pre-specified signal when receiving a signal related to Bluetooth audio mode switching from the portable terminal through the communication circuit, and switch the media mode of the vehicle to the Bluetooth audio mode when the received signal is the pre-specified signal. The specified signal may include at least some signals transmitted and received through, for example, an audio/video distribution transport protocol (AVDTP) and an audio/video control transport protocol (AVCTP). Alternatively, the specified signal may include an audio data signal that is actually transmitted and received.

As an example, the vehicle processor 150 may check the type of the portable terminal 200 in relation to the Bluetooth audio mode switching, and differentiate the pre-specified signal compared to the received signal according to the type of the portable terminal 200. In this regard, the vehicle processor 150 may transmit to the portable terminal 200 a query about checking whether the portable terminal 200 is equipped with a first type operating system, and check the type of the portable terminal according to a response received from the portable terminal 200. Regarding confirmation of the type of portable terminal 200, the vehicle processor 150 may transmit a query including AT+APLSISI to the portable terminal 200 to check whether the portable terminal is equipped with an iOS operating system, and determine that the portable terminal is a portable terminal other than an Apple device when there is no response from the portable terminal or a response value is ‘o’. Alternatively, the vehicle processor 150 may transmit a query including AT+APLSISI to the portable terminal 200 to check whether the portable terminal 200 is equipped with an iOS operating system, and determine that the portable terminal 200 is an Apple device when the response value from the portable terminal 200 is ‘1’ or ‘2’.

As described above, in relation to the operation of the Bluetooth audio function, the vehicle AVNT system 100 may operate an A2DP/AVDTP channel through which actual audio packets are transmitted and an AVRCP/AVCTP channel through which audio information and control commands are exchanged. The AVDTP and AVCTP are lower layer protocols of A2DP/AVRCP, and actually manage the procedures for normally exchanging A2DP and AVRCP packets. The vehicle processor 150 may operate a specified protocol with the portable terminal 200, such as the audio/video distribution transport protocol (AVDTP) and the audio/video control transport protocol (AVCTP), in relation to Bluetooth audio mode operation. The AVDTP is a protocol that defines the negotiation, establishment, and transmission procedures of A/V streaming. The AVCTP is a protocol used to transmit control messages (commands and responses) between compatible devices in A/V applications. In the present disclosure, the vehicle processor 150 may use a stream status signal of AVDTP, audio packet information of A2DP, and playback time information and playback state information of AVRCP.

The state signal of the AVDTP stream may include a stream establishment signal, a stream start signal, and a stream suspended signal. The stream establishment signal may be a signal indicating the process of switching to a ready state (OPEN) for receiving streaming data, and may include a signal requesting entry from the portable terminal 200 when the A2DP is connected. The stream start signal may include a signal transmitted as a state notification before the portable terminal 200 starts transmitting actual streaming data (audio packets). The stream suspended signal may include a signal indicating the process of switching back to the ready state (OPEN) without transmitting audio data, such as pause. The A2DP audio packet information may include an actual audio packet transmitted after transmitting the AVDTP stream start signal. Data based on an audio codec determined during an A/V negotiation process is transmitted/received. Playback time information of AVRCP may include media playback current time information. The vehicle processor 150 may periodically check the current time at which media is played using the playback state information of AVRCP, use event_playback_pos_changed of register notification to check the media playback state in CALLBACK format, and directly check the media playback state in GET format by using SongPostion information of GetPlayStatus. In this case, the vehicle processor 150 may periodically check the current playing time of the music being played using the playback status information of the AVRCP. The register notification signal is a signal that the portable terminal 200 periodically updates the playback time based on the period set by the vehicle AVNT system 100. The GetPlayStatus signal may include a signal that is periodically requested by the vehicle AVNT system 100 and used to check the current playback time.

The vehicle processor 150 may determine whether a request signal intended by the user of the portable terminal 200 is generated in relation to the Bluetooth audio mode switching based on whether the above-described signals, such as a streaming ready state entry signal (avdtp STREAM ESTABLISHMENT), a streaming start signal (avdtp STREAM START), a streaming stop signal (AVDTP STREAM SUSPENDED), and a current order notification confirmation signal (CHECK PLAY POSITION NOTIFICATION) in periodic playback time notification, and a signal indicating an actual audio packet (A2DP AUDIO DATA PACKET), are received, and may perform the Bluetooth audio mode switching based on the determination result.

As another example, the vehicle processor 150 may check information about the type of portable terminal 200 based on whether a specific signal is received. For example, in the case of an iPhone equipped with iOS, the vehicle processor 150 may determine whether the portable terminal 200 is an iPhone or another portable terminal (e.g., an Android terminal) based on whether the AT+APLSIRI signal of RFCOMM is transmitted/received. When the vehicle processor 150 may transmit the AT+APLSIRI of RFCOMM to the portable terminal 200 and determine the portable terminal 200 in the vehicle 11 as an iPhone when receiving a response signal thereto. The AT+APLSIRI signal of the RFCOMM is a signal that may check the Siri feature of an Apple device, and in the case of an Apple device, is a signal configured to generate a normal response. In this regard, the vehicle processor 150 may check the type of the portable terminal 200 requesting the Bluetooth audio mode operation based on the streaming ready state entry signal (avdtp STREAM ESTABLISHMENT), streaming start signal (avdtp STREAM START) and a signal for checking whether the connected device is an Apple device (AT+APLSIRI of RFCOMM), and may process the Bluetooth audio mode change according to the type of the portable terminal 200.

For example, when the portable terminal 200 entering the vehicle 11 is not an Apple device, the vehicle processor 150 may process the Bluetooth audio mode change based on the reception of a streaming start signal (avdtp STREAM START) and a playback position notification check, and a signal representing the actual audio packet (A2dp AUDIO DATA PACKET).

As another example, when the portable terminal 200 entering the vehicle 11 is an Apple device, the vehicle processor 150 may process the Bluetooth audio mode change based on whether a streaming start signal (avdtp STREAM START), AVRCP playback state information, and a signal representing an actual audio packet (A2dp AUDIO DATA PACKET) are received.

Additionally or alternatively, when the vehicle processor 150 receives a signal of instructing streaming stop (e.g., AVDTP Stream Suspended) in the process of monitoring the playback time change, the vehicle processor 150 may return to the streaming ready state and re-perform following operations. For example, vehicle processor 150 may restart a routine that monitors Bluetooth audio mode switching.

Based on the above-described operation, in the vehicle audio operation environment according to an embodiment of the present disclosure, the vehicle AVNT system 100 may determine a Bluetooth audio mode switch request based on whether an A2DP audio packet is received regardless of the type of the portable terminal 200, and perform the Bluetooth audio mode switching. In addition, the vehicle AVNT system 100 may process the Bluetooth audio mode switching based on a playback time update according to the passage of playback time of a media player when the portable terminal 200 equipped with Android OS enters the vehicle 11. In addition, the vehicle AVNT system 100 may process the Bluetooth audio mode switching based on play signal transmission when the portable terminal 200 equipped with Android OS enters the vehicle 11.

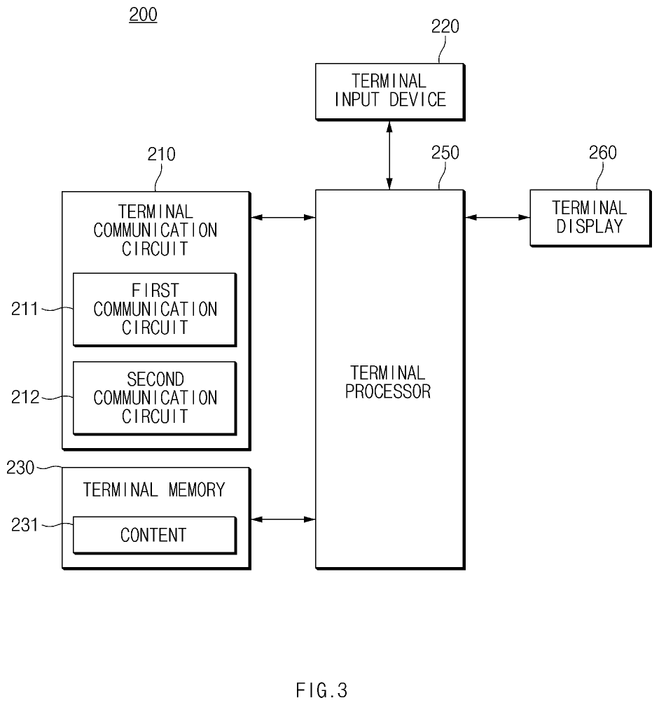

FIG. 3 is a block diagram illustrating an example of a configuration of a portable terminal in a vehicle audio operation environment according to an embodiment of the present disclosure.

Referring to FIG. 3, the portable terminal 200 according to an embodiment of the present disclosure may include a terminal communication circuit 210, a terminal input device 220, a terminal display 260, a terminal memory 230, and a terminal processor 250.

The terminal communication circuit 210 may support a communication function of the portable terminal 200. As an example, the terminal communication circuit 210 may include a first communication circuit 211 that supports a mobile communication function of the portable terminal 200 and a second communication circuit 212 that supports short-range wireless communication (e.g., Bluetooth communication) of the portable terminal 200. The first communication circuit 211 may form a communication channel with an external server device that provides content under control of the terminal processor 250, and may receive data corresponding to the content from the external server device. The content data may be temporarily or semi-permanently stored in the terminal memory 230. The second communication circuit 212 may form a Bluetooth communication channel with the vehicle AVNT system 100 under control of the terminal processor 250, and transmit the content data stored in the terminal memory 230 to the vehicle AVNT system 100. In this process, the second communication circuit 212 may transmit and receive a predefined control signal for forming a Bluetooth communication channel to and from the vehicle AVNT system 100, depending on the type or characteristics of the portable terminal 200 or the installed protocol or operating system, and may transmit data corresponding to content data (or audio data) to the vehicle AVNT system 100 after the Bluetooth communication channel is formed.

The terminal input device 220 may receive user input related to operation of the portable terminal 200. In this regard, the terminal input device 220 may include at least one of a touch key, a touch pad, a touch screen, a physical button, a voice input device, and a gesture input device. The terminal input device 220 may generate at least one of an input signal of requesting connection to an external server device through the first communication circuit 211, an input signal of requesting selection of content provided by the external server device and transmission of data corresponding to the selected content, an input signal of requesting connection to the vehicle AVNT system 100 based on the second communication circuit 212, an input signal of requesting content data stored in the terminal memory 230 or content data being received through the first communication circuit 211 to be transmitted to the vehicle AVNT system, corresponding to the user's manipulation, and may transmit the generated input signal to the terminal processor 250.

The terminal display 260 may output at least one screen related to operation of the portable terminal 200. For example, the terminal display 260 may output at least one of a screen that plays content stored in the terminal memory 230 or content received through connection to an external server device, a screen related to a Bluetooth communication connection with the vehicle AVNT system 100, and a screen that transmits content data to the vehicle AVNT system 100. The terminal display 260 may include a touch screen function, and the terminal display 260 with the touch screen function may support user input generation required when Bluetooth-communication-connecting with the vehicle AVNT system 100.

The terminal memory 230 may store at least one program or data related to the operation of the portable terminal 200. For example, the terminal memory 230 may store at least one content 231, a player (or content playback application) required to play the at least one content 231, and a protocol required for Bluetooth communication connection with the vehicle AVNT system 100.

The terminal processor 250 may perform at least one of transmitting and receiving signals related to the operation of the portable terminal 200, processing signals, and storing processing results. As an example, the terminal processor 250 may control to reproduce the content 231 stored in the terminal memory 230 in response to a user input and output the content 231 through an output device (e.g., an audio device or a wireless headset) provided in the portable terminal 200. The terminal processor 250 may check whether there is an external device to which the content 231 is transmitted by performing peripheral scanning in response to a user input or corresponding to preset scheduling information (e.g., at a certain cycle or in real time). In this process, when the vehicle AVNT system 100 is searched, the terminal processor 250 may output a pop-up window inquiring whether to output the content 231 through the vehicle AVNT system 100. When receiving a user input signal corresponding to a request to output the content 231 through the vehicle AVNT system 100, the terminal processor 250 may transmit a control signal for Bluetooth communication connection with the vehicle AVNT system 100, and transmit the content 231 (or content data, or audio data) to the vehicle AVNT system 100 based on a Bluetooth communication channel corresponding to switching to the Bluetooth audio mode of the vehicle AVNT system 100. Alternatively, when the vehicle AVNT system 100 is searched, the terminal processor 250 may automatically perform procedures necessary to output the content 231 through the vehicle AVNT system 100.

As described above, in relation to the transmission of played content 231, when the vehicle AVNT system 100 enters a communication standby mode for receiving and outputting the content 231 from the portable terminal 200 regardless of the operation of the vehicle AVNT system 100, the portable terminal 200 may support the Bluetooth audio mode switching of the vehicle AVNT system 100 just by manipulating the portable terminal 200, and when the Bluetooth audio mode switching of the vehicle AVNT system 100 is completed, the portable terminal 200 may transmit the content 231 to the vehicle AVNT system 100 through based on the Bluetooth communication channel.

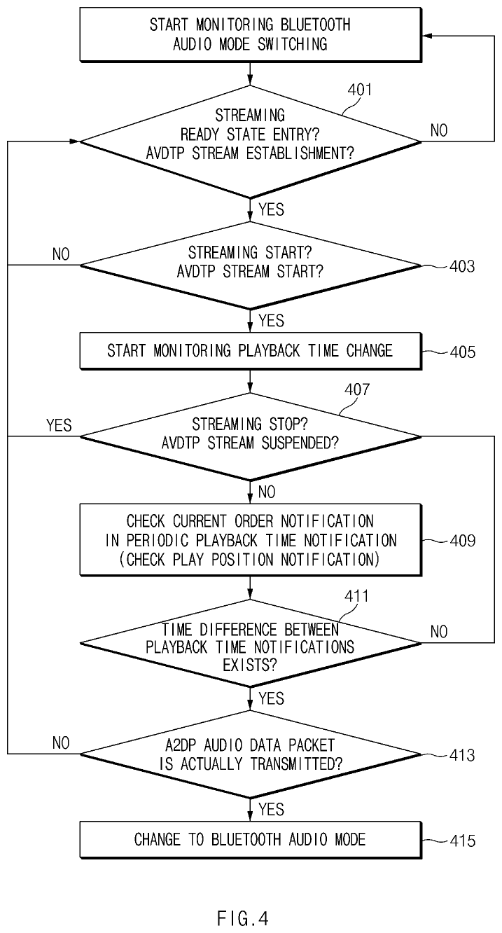

FIG. 4 is a flowchart illustrating an example of a method of operating a Bluetooth audio mode of a vehicle AVNT system according to an embodiment of the present disclosure.

Referring to FIG. 4, in relation to a method of operating a Bluetooth audio mode according to an embodiment of the present disclosure, the vehicle processor 150 of the vehicle AVNT system 100 may start monitoring Bluetooth audio mode switching according to a specified condition. For example, the vehicle processor 150 may execute a routine set for monitoring Bluetooth audio mode switching when the ignition of the vehicle 11 is turned on or when pressure exceeding a predefined reference value is applied to the accelerator of the vehicle 11. Alternatively, the vehicle processor 150 may control execution of a routine for monitoring when the driver or passenger gets on the vehicle after the ignition is turned on. In this regard, the vehicle 11 may further include a sensor capable of detecting the presence of a driver or passenger therein. In relation to execution of the routine for the monitoring, the vehicle AVNT system 100 may be in a communication standby state (e.g., a state in which the Bluetooth communication module is activated) and in a state of supporting a specific media mode based on preset information. For example, the vehicle AVNT system 100 may support the output of audio data according to the radio or automatic playback of contents stored in the storage device of the vehicle 11. As described above, the vehicle AVNT system 100 may execute the monitoring routine for switching to Bluetooth audio mode in a standby state or a state of supporting a specific media mode.

In operation 401, the vehicle processor 150 may check whether a signal related to the streaming ready state entry (AVDTP Stream Establishment) is received. When there is no signal reception related to the streaming ready state entry, the vehicle processor 150 may return to the previous state (e.g., a state in which a monitoring routine for switching to the Bluetooth audio mode is executed) and check operation 401 in real time or at a certain cycle.

When the signal related to the streaming ready state entry (AVDTP Stream Establishment) is received, in operation 403, the vehicle processor 150 may check whether a signal (AVDTP Stream Start) related to streaming start is received. When the vehicle processor 150 does not receive the signal (AVDTP Stream Start) related to streaming start, the vehicle processor 150 may branch to operation 401 and re-perform the following operations.

When the vehicle processor 150 receives the signal (AVDTP Stream Start) related to streaming start, in operation 405, the vehicle processor 150 may start monitoring the playback time change. In this regard, the vehicle processor 150 of the vehicle AVNT system 100 may execute the routine for monitoring the playback time change and in operation 407, check whether a signal (AVDTP Stream Suspended) related to a streaming stop is received. When the signal (AVDTP Stream Suspended) related to a streaming stop is received, the vehicle processor 150 may branch to operation 401 and re-perform the following operations. For example, the vehicle processor 150 may restart the monitoring routine for Bluetooth audio mode switching.

When the signal (AVDTP Stream Suspended) related to a streaming stop is not received, in operation 409, the vehicle processor 150 may check the current order notification in the periodic playback time notification. In this regard, the vehicle processor 150 may check information related to the play position notification in the signal transmitted by the portable terminal 200 (Check play position notification).

In operation 411, the vehicle processor 150 may check whether there is a time difference between playback time notifications. When there is no time difference between playback time notifications, the vehicle processor 150 may branch to operation 407 and re-perform the following operations.

When there is a time difference between each playback time notification, the vehicle processor 150 may check whether the A2DP audio data packet is actually transmitted in operation 413. When the A2DP audio data packet is not actually transmitted, the vehicle processor 150 may branch to operation 401 and re-perform the following operations. Meanwhile, when the actual A2DP audio data packet is transmitted, the vehicle processor 150 may change to the Bluetooth audio mode in operation 415 and control the audio data transmitted by the portable terminal 200 to be output through the vehicle audio system.

As described above, a method of operating a Bluetooth audio mode according to an embodiment of the present disclosure may perform switching to the Bluetooth audio mode in response to the operation of the portable terminal 200 without direct user operation (or input) to the vehicle AVNT system 100, so that it is possible to provide a more convenient and safer content playback environment.

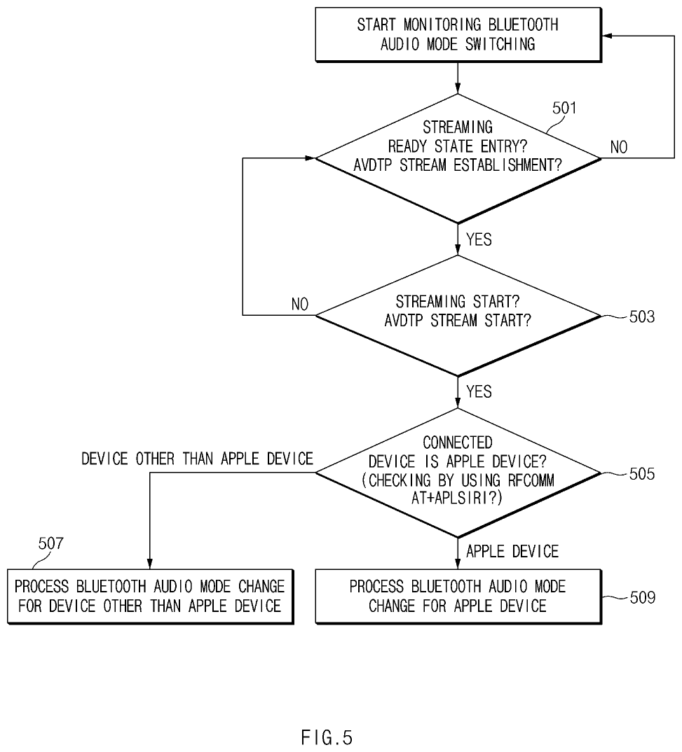

FIG. 5 is a flowchart illustrating another example of a method of operating a Bluetooth audio mode of a vehicle AVNT system according to an embodiment of the present disclosure.

Referring to FIG. 5, in relation to a method of operating a Bluetooth audio mode according to an embodiment of the present disclosure, the vehicle processor 150 of the vehicle AVNT system 100 may start monitoring Bluetooth audio mode switching according to a specified condition. For example, when the ignition of the vehicle 11 is turned on, a pressure exceeding a predefined reference value is applied to the accelerator of the vehicle 11, or it is detected that a user is in the driver's seat, passenger seat, or other seats, the vehicle processor 150 may perform a loop execution (or routine execution) related to starting the corresponding monitoring. The operation of the vehicle processor 150 related to starting monitoring for switching to the Bluetooth audio mode may be the same or similar to the monitoring starting operation described previously in FIG. 4.

In operation 501, the vehicle processor 150 may determine whether the signal related to the streaming ready state entry (AVDTP Stream Establishment) is received. When there is no reception of a signal related to the streaming ready state entry, the vehicle processor 150 may return to the previous state (e.g., a state in which a monitoring routine for switching to the Bluetooth audio mode is executed) and check operation 501 in real time or at a certain cycle.

When the signal related to the streaming ready state entry (AVDTP Stream Establishment) is received, in operation 503, the vehicle processor 150 may check whether a signal related to streaming start (AVDTP Stream Start) is received. When the vehicle AVNT system 100 completes confirmation of a signal (AVDTP Stream Start) from which content data (or audio data or streaming data) transmitted in the Bluetooth audio mode begins to be transmitted, the vehicle AVNT system 100 may start a loop set up to check for a trigger condition to switch to the Bluetooth audio mode (e.g., monitoring a playback time change). Additionally or alternatively, when a pause, which temporarily suspends content playback, is performed in the portable terminal 200, the vehicle AVNT system 100 may switch into a suspended state, branch to operation 501, and re-perform the following operations.

When a signal related to streaming start (AVDTP Stream Start) is received, the vehicle processor 150 may perform a process for checking whether the connected device is a specified portable terminal (e.g., an Apple device) in operation 505. For example, the vehicle processor 150 may transmit an AT+APLSIRI signal to the portable terminal 200 and check whether+Aplsiri: X (where x is one of 0, 1, or 2) is received from the portable terminal 200. When a response is not received from the portable terminal 200 within a specified time or +aplsiri: 0 is received as a response, in operation 507, the vehicle processor 150 may determine that the portable terminal 200 is a device other than a specific portable terminal (e.g., an Apple device) and perform a Bluetooth audio mode change process accordingly.

Meanwhile, when +aplsiri: 1 or 2 is received from the connected portable terminal 200 in operation 505, the portable terminal 200 may be determined as a specified type portable terminal, and the specific type portable terminal (e.g., an Apple device) may perform the Bluetooth audio mode change process.

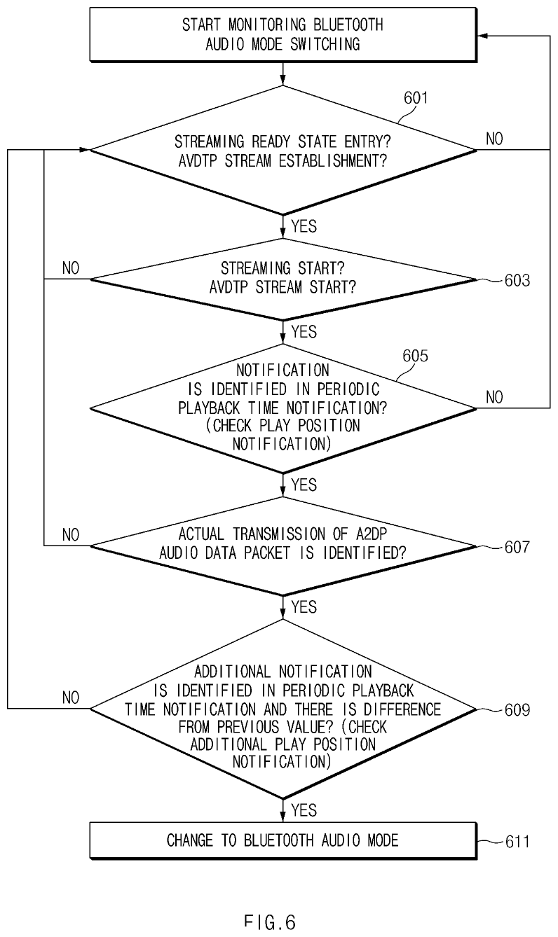

FIG. 6 is a diagram illustrating an example of a method of operating a Bluetooth audio mode of a vehicle AVNT system related to a first type portable terminal according to an embodiment of the present disclosure. In this case, the first type portable terminal may include, for example, a device (e.g., an Android device) other than a specified type portable terminal (e.g., an Apple device).

Referring to FIG. 6, in relation to a method of operating a Bluetooth audio mode according to an embodiment of the present disclosure, the vehicle processor 150 of the vehicle AVNT system 100 may start monitoring Bluetooth audio mode switching according to a specified condition. As an example, in operation 601, the vehicle processor 150 may determine whether the signal related to the streaming ready state entry (AVDTP Stream Establishment) is received. When there is no reception of a signal related to the streaming ready state entry, the vehicle processor 150 may return to the previous state (e.g., a state in which a monitoring routine for switching to the Bluetooth audio mode is executed) and check operation 601 in real time or at a certain cycle. When the signal related to the streaming ready state entry (AVDTP Stream Establishment) is received, in operation 603, the vehicle processor 150 may check whether a signal related to streaming start (AVDTP Stream Start) is received. When the vehicle processor 150 does not receive the signal (AVDTP Stream Start) related to streaming start, the vehicle processor 150 may branch to operation 601 and re-perform the following operations.

When the signal related to streaming start (AVDTP Stream Start) is received, the vehicle processor 150 may check whether there is a notification in the periodic playback time notification in operation 605 (Check play position notification). When a separate notification is not confirmed, the vehicle processor 150 may branch to operation 601 and perform the following operations.

When the periodic play time notification is confirmed, the vehicle processor 150 may check whether the A2DP audio data packet is actually transmitted in operation 607. When the A2DP audio data packet is not actually transmitted, the vehicle processor 150 may branch to operation 601 and re-perform the following operations. Meanwhile, when the actual A2DP audio data packet is transmitted, in operation 609, the vehicle processor 150 may additionally check the periodic playback time notification and check whether there is a difference from the previous value (Check additional play position notification). When there is no additional notification confirmation in the periodic playback time notification or there is no difference between the play time notification and the previous value, the vehicle processor 150 may branch to operation 601 and re-perform the following operations.

When there is an additional notification confirmation in the periodic playback time notification and the playback time notification is different from the previous value, the vehicle processor 150 may branch to operation 611 and change to the Bluetooth audio mode, such that the audio data transmitted by the portable terminal 200 is controlled to be output through the vehicle audio system.

Meanwhile, in the process of performing the procedure related to the above-described Bluetooth audio mode operation, when receiving a control signal related to a temporary stop (e.g., a pause) from the portable terminal 200, the vehicle processor 150 may stop the currently executing procedure, branch to operation 601, and re-perform the following operations.

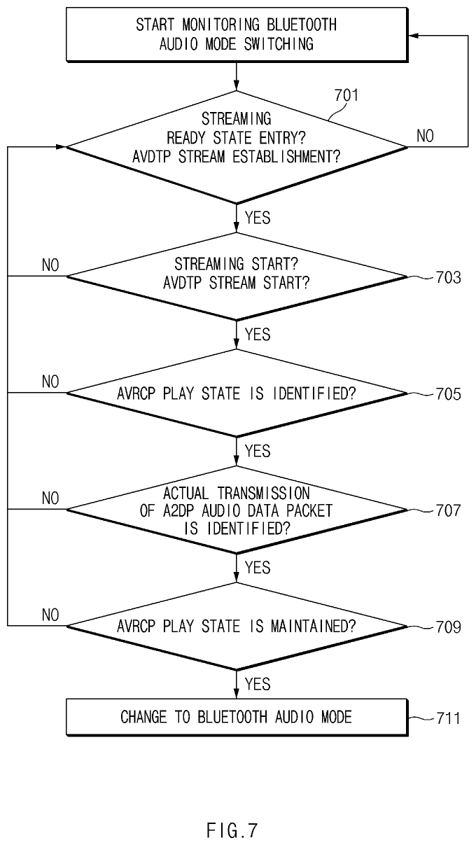

FIG. 7 is a diagram illustrating an example of a method of operating a Bluetooth audio mode of a vehicle AVNT system related to a second type portable terminal according to an embodiment of the present disclosure. In this case, the second type portable terminal, which is a specified type of portable terminal, may include, for example, an Apple device.

Referring to FIG. 7, in relation to a method of operating a Bluetooth audio mode according to an embodiment of the present disclosure, the vehicle processor 150 of the vehicle AVNT system 100 may execute a routine related to starting monitoring for Bluetooth audio mode switching according to a specified condition. As an example, similarly to operation 601 previously described in FIG. 6, and the like, in operation 701, the vehicle processor 150 may determine whether the signal related to the streaming ready state entry (AVDTP Stream Establishment) is received. When there is no reception of a signal related to the streaming ready state entry, the vehicle processor 150 may return to the previous state (e.g., a state in which a monitoring routine for switching to the Bluetooth audio mode is executed) and check operation 701 in real time or at a certain cycle. When the signal related to the streaming ready state entry (AVDTP Stream Establishment) is received, identically with operation 603 described above, in operation 703, the vehicle processor 150 may check whether a signal related to streaming start (AVDTP Stream Start) is received. When the vehicle processor 150 does not receive the signal (AVDTP Stream Start) related to streaming start, the vehicle processor 150 may branch to operation 701 and re-perform the following operations.

When the signal related to streaming start (AVDTP Stream Start) is received, the vehicle processor 150 may check the AVRCP play state in operation 705. When the signal indicating the AVRCP play state is not received, the vehicle processor 150 may branch to operation 701 and perform the following operations.

When receiving a signal indicating the AVRCP play state, in operation 707, the vehicle processor 150 may check whether the A2DP audio data packet is actually transmitted. When the A2DP audio data packet is not actually transmitted, the vehicle processor 150 may branch to operation 701 and re-perform the following operations. Meanwhile, when the actual A2DP audio data packet is transmitted (or while being transmitted), in operation 709, the vehicle processor 150 may check whether the AVRCP play state is maintained. When the AVRCP play state is not maintained, the vehicle processor 150 may branch to operation 701 and re-perform the following operations.

When the AVRCP play state is maintained, the vehicle processor 150 may branch to operation 701 and change to the Bluetooth audio mode, such that the audio data transmitted by the portable terminal 200 is controlled to be output through the vehicle audio system.

Meanwhile, in the process of performing the procedure related to the above-described Bluetooth audio mode operation, when receiving a control signal related to a temporary stop (e.g., a pause) from the portable terminal 200, the vehicle processor 150 may stop the currently executing procedure, branch to operation 701, and re-perform the following operations.

Additionally or alternatively, embodiments of the present disclosure may include a vehicle computing system capable of performing at least some of the Bluetooth audio operation methods described in FIGS. 4 to 7.

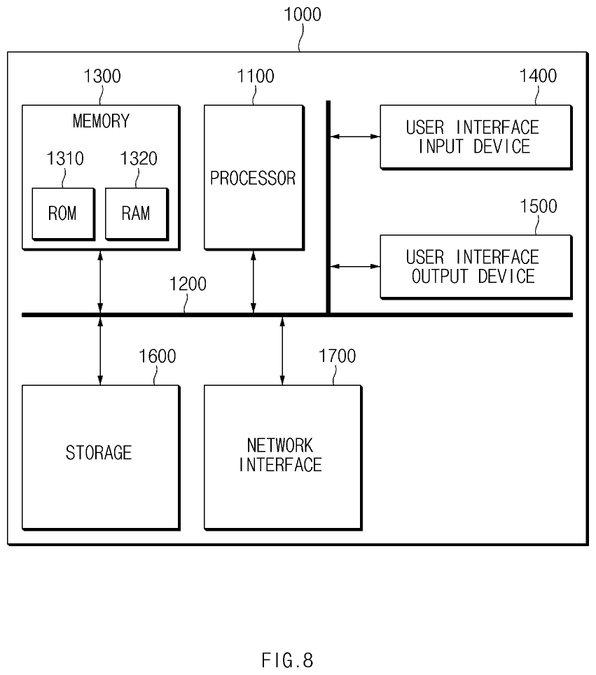

FIG. 8 is a block diagram illustrating a computing system according to each embodiment of the present disclosure.

Referring to FIG. 8, a computing system 1000 may include at least one processor 1100, a memory 1300, a user interface input device 1400, a user interface output device 1500, storage 1600, and a network interface 1700 connected through a bus 1200. The computing system 1000 illustrated in FIG. 8 may be a system that may be applied at least in part to the vehicle 11 described with reference to FIGS. 1 to 3, and may be a computing system that may perform the method of providing an improved security function for a vehicle described with reference to FIG. 8.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the embodiments of the present disclosure, it is possible to improve the usability of the Bluetooth audio mode by making it easier to operate the Bluetooth audio mode of a portable terminal.

In addition, various effects that are directly or indirectly understood through the present disclosure may be provided.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A vehicle control device comprising:
a communication circuit configured to provide a communication channel with a portable terminal; and
a vehicle processor functionally connected to the communication circuit,
wherein the vehicle processor is configured to:
start a monitoring routine to switch a media mode of a vehicle to a Bluetooth audio mode;
check whether a received signal is a pre-specified signal when a signal related to a Bluetooth audio mode switch is received from the portable terminal through the communication circuit; and
switch the media mode to the Bluetooth audio mode when the received signal is the pre-specified signal.

2. The vehicle control device of claim 1, wherein the vehicle processor is configured to perform the Bluetooth audio mode switch when there is a time difference between playback time notifications related to a periodic playback time notification and a received actual advanced audio distribution profile (A2DP) audio data packet after a streaming ready state entry signal and a streaming start signal are received.

3. The vehicle control device of claim 2, wherein the vehicle processor is configured to restart a routine of monitoring the Bluetooth audio mode switch when receiving a streaming stop signal.

4. The vehicle control device of claim 1, wherein the vehicle processor is configured to compare the pre-specified signal to the received signal by checking a type of the portable terminal.

5. The vehicle control device of claim 4, wherein the vehicle processor is configured to:
transmit to the portable terminal a query about checking whether the portable terminal is equipped with a first type operating system; and
check the type of the portable terminal according to a response received from the portable terminal.

6. The vehicle control device of claim 5, wherein the vehicle processor is configured to:
transmit a query including AT+APLSISI to the portable terminal to check whether the portable terminal is equipped with an iOS operating system; and
determine that the portable terminal is an Apple® device when a response value from the portable terminal is 1 or 2.

7. The vehicle control device of claim 6, wherein the vehicle processor is configured to:
check whether an actual advanced audio distribution profile (A2DP) audio data packet is received when checking an audio/video remote control profile (AVRCP) play state, wherein the vehicle processor is in the AVRCP play state after receiving a streaming ready state entry signal and a streaming start signal when it is determined that the portable terminal is the Apple® device, and
switch to the Bluetooth audio mode when the AVRCP play state is maintained while receiving the A2DP audio data packet.

8. The vehicle control device of claim 4, wherein the vehicle processor is configured to:
transmit a query including AT+APLSISI to the portable terminal to check whether the portable terminal is equipped with an iOS operating system; and
determine that the portable terminal is a portable terminal other than an Apple® device when there is no response from the portable terminal or when a response value is 0.

9. The vehicle control device of claim 8, wherein the vehicle processor is configured to:
check a periodic playback time notification after receiving a streaming ready state entry signal and a streaming start signal when determining that the portable terminal is a portable terminal other than the Apple® device,
check whether an actual advanced audio distribution profile (A2DP) audio data packet is received when the periodic playback time notification is confirmed, and
switch to the Bluetooth audio mode when there is a time difference between the periodic playback time notifications and the actual A2DP audio data packet.

10. A method comprising:
starting, by a processor of a vehicle, a monitoring routine to switch a media mode of the vehicle to a Bluetooth audio mode;
checking, by the processor, whether a signal from a portable terminal through a communication circuit of the vehicle is received, the signal being related a Bluetooth audio mode switch;
determining, by the processor, whether the received signal is a pre-specified signal; and
switching, by the processor, the media mode to the Bluetooth audio mode when the received signal is the pre-specified signal.

11. The method of claim 10, wherein checking whether the signal is received comprises checking whether there is a time difference between playback time notifications related to a periodic playback time notification and an actual advanced audio distribution profile (A2DP) audio data packet after a streaming ready state entry signal and a streaming start signal are received.

12. The method of claim 11, wherein checking whether the signal is received further comprises restarting a routine of monitoring the Bluetooth audio mode switch after receiving a streaming stop signal.

13. The method of claim 10, wherein checking whether the signal is received comprises comparing the pre-specified signal to the received signal by checking a type of portable terminal.

14. The method of claim 13, wherein checking the type of portable terminal comprises:
transmitting, to the portable terminal, a query about whether the portable terminal is equipped with a first type operating system; and
checking the type of the portable terminal according to a response received from the portable terminal.

15. The method of claim 14, wherein checking the type of portable terminal comprises:
transmitting a query including AT+APLSISI to the portable terminal to check whether the portable terminal is equipped with an iOS operating system; and
determining that the portable terminal is an Apple® device when a response value from the portable terminal is 1 or 2.

16. The method of claim 15, wherein switching to the Bluetooth audio mode comprises:
checking whether an actual advanced audio distribution profile (A2DP) audio data packet is received when checking an audio/video remote control profile (AVRCP) play state, wherein the processor is in the AVRCP play state after receiving a streaming ready state entry signal and a streaming start signal when it is determined that the portable terminal is the Apple® device, and switching to the Bluetooth audio mode when the AVRCP play state is maintained while receiving the A2DP audio data packet.

17. The method of claim 13, wherein checking the type of the portable terminal comprises:
transmitting a query including AT+APLSISI to the portable terminal to check whether the portable terminal is equipped with an iOS operating system; and
determining that the portable terminal is a portable terminal other than an Apple® device when there is no response from the portable terminal or when a response value is 0.

18. The method of claim 17, wherein switching to the Bluetooth audio mode comprises:
checking a periodic playback time notification after receiving a streaming ready state entry signal and a streaming start signal when determining that the portable terminal is a portable terminal other than the Apple® device,
checking whether an actual advanced audio distribution profile (A2DP) audio data packet is received when the periodic playback time notification is confirmed, and
switching to the Bluetooth audio mode when there is a time difference between the periodic playback time notifications and the actual A2DP audio data packet.

19. A vehicle computer system of a vehicle comprising:
a vehicle processor configured to support a vehicle operation; and
a memory configured to store at least one instruction for operating the vehicle processor,
wherein the at least one instruction stored in the memory causes the vehicle processor to:
start a monitoring routine to switch a media mode of the vehicle to a Bluetooth audio mode;
check whether a signal related to a Bluetooth audio mode switch is received from a portable terminal through a communication circuit of the vehicle;
determine whether the received signal is a pre-specified signal; and
switch the media mode to the Bluetooth audio mode when the received signal is the pre-specified signal.

20. The vehicle computer system of claim 19, wherein the at least one instruction causes the vehicle processor to restart a routine of monitoring the Bluetooth audio mode switch when a streaming stop signal is received.
